(19) United States
(12) Patent Application Publication
(10) Pub. No.: US 2017/0346375 A1
(43) Pub. Date: Nov. 30, 2017

(54) Gravity Induced, Bucky-Ball Based, Power Plant - "Shlomo Pillar"

(71) Applicant: Sidney Shlomo BEN-DAN, HERZLYA (IL)

(72) Inventor: Sidney Shlomo BEN-DAN, HERZLYA (IL)

(21) Appl. No.: 15/164,900

(22) Filed: May 26, 2016

(51) Int. Cl. H02K 35/02; H02K 41/03; H02K 53/00

(52) U.S. Cl. CPC H02K 35/02; H02K 41/031; Y10S 74/09; H02K 53/00

(57) ABSTRACT

The Gravity Induced Power Plant is an electricity generator based on the free fall (gravity induced) of capsules loaded with highly magnetized buckminsterfullerene (or bucky-ball) along a helical tube. The power plant is self-sustained by lifting the capsules by means of magnetic levitation. The power plant is intended to provide emission-free electrical power and to be environmental friendly.

Differing from a standard electromagnetic generator, the rotor consists of one or more static helical tube(s) where the magnetized capsules rotate in their descent along a central rod. This static rod functions as the stator, as in any conventional generator.

This power generator is intended to be installed in any environment. However, its inherent design makes it particularly suitable for sky free areas such as desert expanses.

The derived electricity is used to power various systems in a local area including, for example, a communications base station, an air-conditioning system for a full school and more.

Setting several units in a close area may create a medium size electric power plant that provides electricity to a small community.

The whole system is dubbed Shlomo Pillar due to its standing rod configuration.

### CROSS REFERENCE TO RELATED APPLICATIONS

This application is a continuation-in-part of U.S. Provisional Patent Application No. 62/162,757, entitle U.S. Provisional Patent Application No. d “Gravity Induced, Bucky-Ball Based, Power Plant “Shlomo Pillar””, filed on May 17, 2015, the entire contents of this application are expressly incorporated herein.

### FIELD OF THE INVENTION

This invention relates in general to the construction of earth gravity, solar and/or wind power plants and, in particular, to a new and useful electricity generator based on the free fall (gravity induced) of capsules loaded with highly magnetized buckminsterfullerene (or bucky-ball) along a helical tube. The invention is intended to:
Provide an alternative electrical power plant
Free of emissions power plant
Relatively low cost power plant
Standalone power plant, or grid connected
Environmental friendly power supply
Provide solution in remote locations.

### BACKGROUND OF THE INVENTION

The Gravity Induced Power Plant is an electricity generator based on the free fall (gravity induced) of capsules loaded with highly magnetized buckminsterfullerene (or bucky-ball) along a helical tube, and their lift on magnetic levitation. The power plant 1 is intended to provide emission free electricity and to be environmental friendly.

Opposite to any electromagnetic generator, the rotor consists of one or more helical tube(s) where the magnetized capsules rotate in their descent along the central static rod, which functions as a stator.

The initial setup requires the manufacturing of the ferrite bucky-balls to be inserted in capsules. This product can turn out cheap since the main ingredients are carbon and iron, which are plentiful.

Currently, the bucky-balls are not employed for power plants, and this invention is an innovation

The whole system is dubbed Shlomo Pillar due to its standing rod configuration Shlomo Pillars can be installed in a variety of environments, and do not require neither vast expanses as solar panel power plants nor specific geographical location as wind farms.

### BRIEF DESCRIPTION OF THE FIGURES

FIG. 1 is a front perspective of the gravity induced, bucky-ball based, power plant (dubbed Shlomo Pillar) according to one embodiment of the invention, with the solar panels, helical tubes and the magnetic levitation lift system.

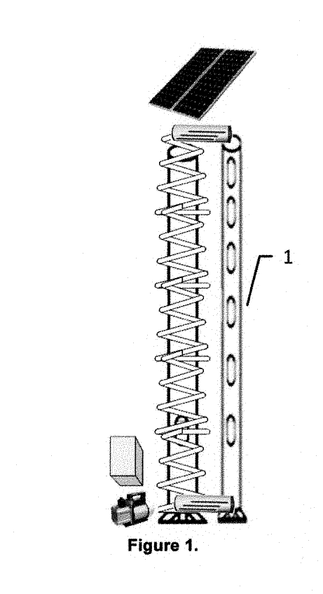

FIG. 2 is a list of the main components of the power plant and their relative location in the system.

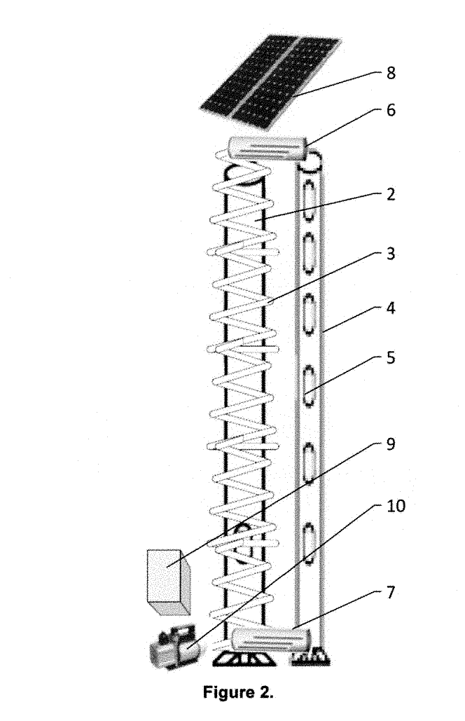

FIG. 3 is an orthogonal projection of the general architecture of the buckminsterfullerene (or bucky-ball).

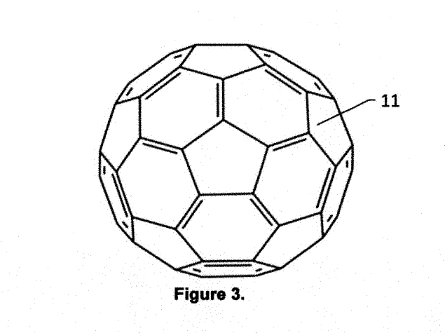

FIG. 4 is a 3D perspective view of the buckminsterfullerene (or bucky-ball).

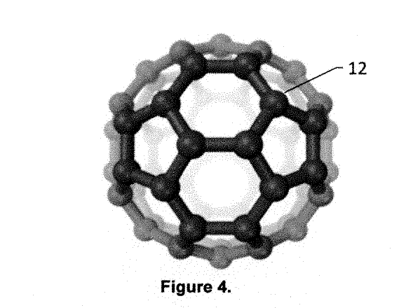

FIG. 5 is a perspective view of the capsule that will enclose the bucky-balls.

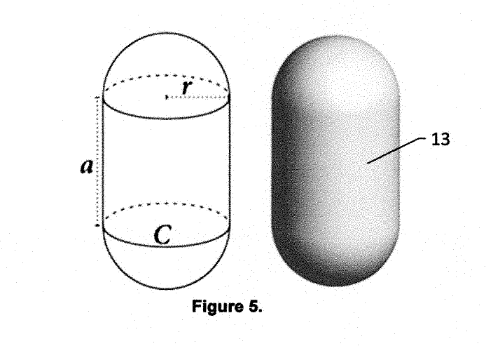

FIG. 6 is a perspective view of the lift system based on magnetic levitation that will propel the capsules up in the return tube.

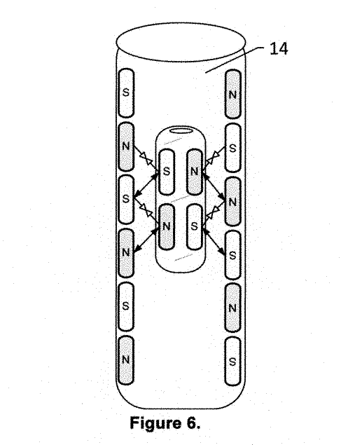

FIG. 7 is a diagram of the flight path of the capsule within the return tube.

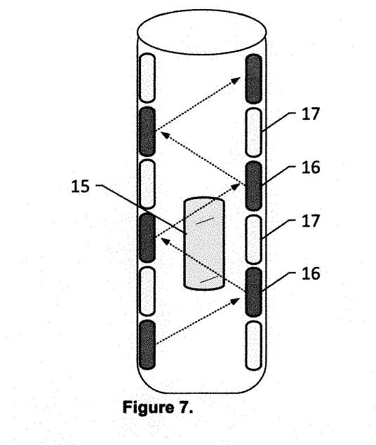

FIG. 8 is a diagram and perspective view of the tube for the descent of the capsules, creating an electromagnetic field that produces power.

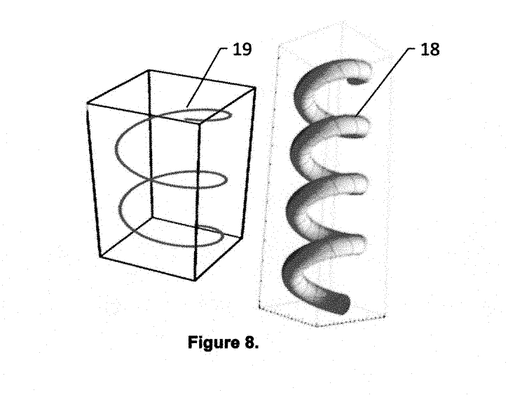

FIG. 9 is a diagram of the different configurations of the helical tube that transport the capsules.

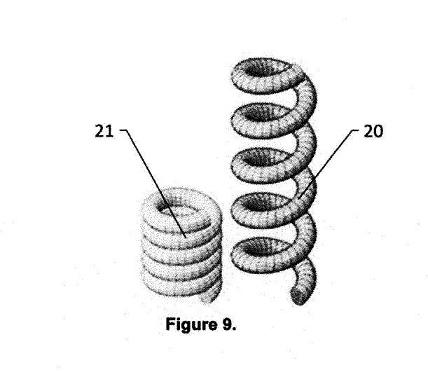

FIG. 10 is a diagram of the rotor composed of parallel helices, showing the possibility of creating a rotor out of adjacent coils.

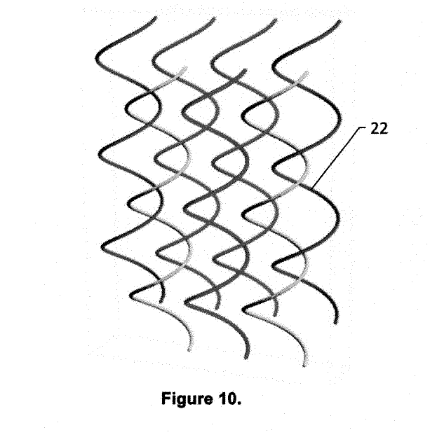

FIG. 11 is a diagram of the helices designed as archimedean spiral.

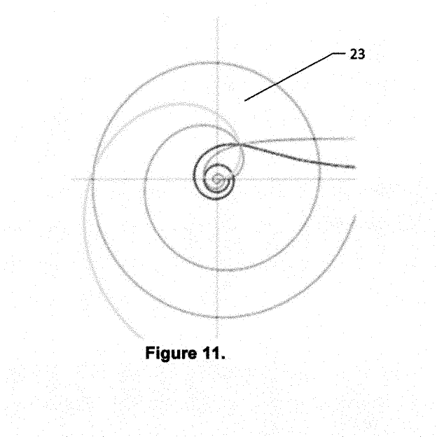

FIG. 12 is a diagram of a power plant set of several units in a single line configuration, creating a wall configuration.

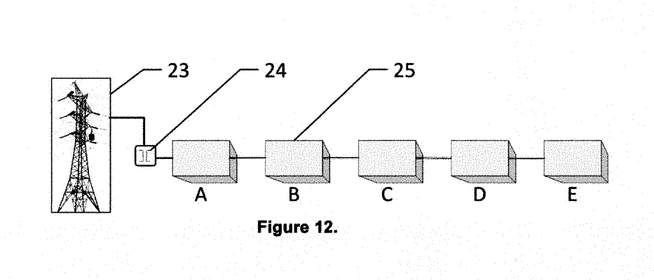

FIG. 13 is a diagram of a power plant made of several units in a circular configuration, creating a circus configuration.

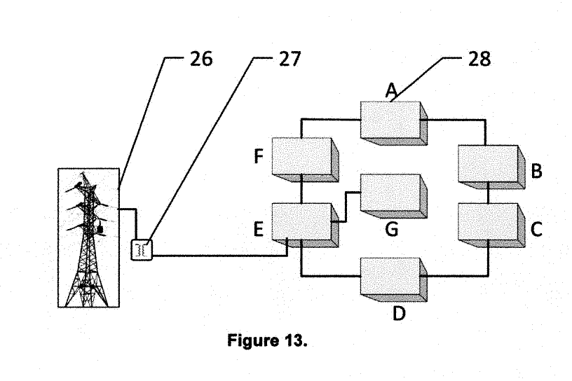

### DESCRIPTION OF THE INVENTION

At start, the top dispenser 6 releases, in a controlled rate, capsules 5 filled with highly magnetized bucky-balls. As they descend, due to earth gravity pull along a spiral 3, the electromagnetic induction in the coil performs as the rotor in an electrical generator where the central rod 2 is the stator. Production can be increased by setting several coils adjacently along the central rod.

There is the possibility to use an archimedean spiral in order to ensure fast movement of the capsules at the bottom of the helix. Just as well, the descent system includes an air pump 10 that sucks the air in the spiral in order to lower the friction and pressure of air in the descent process. The pump is not intended to create a vacuum since atmospheric pressure may structurally damage the spiral.

Once the capsule reaches the bottom of the tube, it is directed to the lift system 4 by the bottom dispenser 7. The bottom dispenser operates as an inertial force for the magnetic levitation control system 4. This system controls the capsule 5 upward movement. The capsule crisscrosses the lift system that uses alternating magnetic attraction to pull the capsule upwards against gravity.

The magnetic levitation control system is powered by the solar panels 8 installed at the top of the power system. The system also includes a backup power supply in the form of powerwall batteries 9 that provide power by night or other circumstances such as cloudy days.

When the capsule reaches the top, it is collected by the top dispenser 6. The same process described at the start of this paragraph is performed anew. The output electricity is fed to the local power grid 23 & 26. The system can work continuously by night, where power demand is lower, by controlling the dispenser feed in the system and feeding it from the powerwall batteries. In order to obtain a substantial power plant out of Shlomo Pillars, there is the need to install several units in different configurations (Wall 25 or Circus 28, or any other).

As described above, the Shlomo Pillar power plant shall be installed in a suitable environment, properly calibrated and monitored, and turned on. Beside periodic maintenance, Shlomo Pillars require no user intervention but does require monitoring due to the partial dependence on sunlight power.

Main Components

The Shlomo Pillar consists of the following main components:
Stator—Rod 2
Rotor—Helical Tube, one or more 3
Magnetic Levitation Lift System 4
Bucky-ball Capsules 5
Capsules Dispensers—Top and Bottom 6
Lift System 7
Solar Panel 8
Powerwall Battery 9
Vacuum Pump 10.

Magnetized Bucky-Balls

The buckminsterfullerene (or bucky-ball) is a spherical fullerene molecule with the formula C60. It has a cage-like fused-ring structure (truncated icosahedron) which resembles a soccer ball, made of twenty hexagons and twelve pentagons, with a carbon atom at each vertex of each polygon and a bond along each polygon edge 11.

One potentially useful property is fullerene's large-capacity internal spaces. Atoms of different elements 12 may be placed inside the molecular cage formed by the carbon atoms, producing a shrink-wrapped version of these elements.

The C60 molecule is extremely stable withstanding high temperatures and high pressures. The exposed surface of the structure can selectively react with other species while maintaining the spherical geometry. Atoms and small molecules can be entrapped at the interior without reacting.

However, the bucky-balls intended for the Shlomo Pillar power plant shall be produced with ferrites, in order to induce in them ferrimagnetism. Different ferromagnetic materials, beside iron, can be proposed in order to increase the residual magnetism in iron, which is generally weak since iron is soft. Some alloying with cobalt or nickel, etc. may be needed in order to make the material hard enough to retain the magnetism.

Although fullerenes are sparingly soluble in aromatic solvents such as toluene and carbon disulfide, the proposed solution is requested in solid form.

C60 solid is as soft as graphite, but when compressed to less than 70% of its volume it transforms into a superhard form of diamond. Fcc C60 contains voids at its octahedral and tetrahedral sites which are sufficient large (0.6 and 0.2 nm respectively) to accommodate impurity atoms. When alkali metals are doped into these voids, C60 converts from a semiconductor into a conductor or eve superconductor.

Intercalation of alkali-metal atoms in solid C60 has been found (Haddon et al., 1991) to lead to metallic behavior. Furthermore, in special physical conditions, C60 becomes superconductive.

Just as well, when the C60 solid is doped with metal atoms, the metal atoms give electrons to the t1u band or the upper 3-fold t1g band. This partial electron occupation of the band may lead to metallic behavior.

The application of high pressure decreases the interfullerene spacing, therefore cesium-doped C60 solids turn to metallic and superconducting. Metal atoms can be encapsulated inside the C60 cage. These endohedral fullerenes are usually synthesized by doping in the metal atoms in an arc reactor or by laser evaporation. These methods give low yields of endohedral fullerenes. A better method involves the opening of the cage, packing in the atoms or molecules, and closing the opening using certain organic reactions.

Capsules

Out of a range of techniques, the preferred method of packaging the bucky-balls is encapsulation 13. This technique shall enable to enclose the bucky-balls in a relatively stable shell. The hard-shelled capsules are suitable to contain dry, powdered ingredients or miniature pellets such as the bucky-balls. The capsules are made of two parts, the main body and the upper cape. Inserting the bucky-balls, already magnetized, can be performed by activating a magnet at the bottom of the open capsule which shall attract the balls to the bottom.

This delivery method, particularly if the capsules are plasticized, can be flexible enough to move with lower friction along the helical tube, and allow for some degree of bending at the helix turns.

Capsule Lift System—Magnetic Levitation

Magnetic levitation, maglev, or magnetic suspension is a method by which an object is suspended with no support other than magnetic fields. Magnetic pressure is used to counteract the effects of the gravitational and any other accelerations.

However, the lift system 14 is not a maglev system but its functional principle is very similar.

By using only ferromagnetic or paramagnetic materials, it is impossible to stably levitate against gravity. Magnetic levitation requires an initial force for moving forward an object. This system uses the angular velocity of the capsule at the end of the helix descent. The resulting momentum shall provide the initial force to move the capsule 15 up in the lift system, until the maglev system takes over.

Although the lifting force is provided by magnetic levitation, but there is a mechanical support providing a small load that provides stability. This is termed pseudo-levitation.

For successful levitation and control, a combination of permanent magnets 16 & 17 and electromagnets or dia-magnets or superconductors as well as attractive and repulsive fields can be used.

With a small amount of mechanical constraint for stability, achieving pseudo-levitation is a relatively straightforward process. If two magnets are mechanically constrained along a single vertical axis, for example, and arranged to repel each other strongly, this will act to levitate one of the magnets above the other.

Stable magnetic levitation can be achieved by measuring the position and speed of the object being levitated, and using a feedback loop which continuously adjusts one or more electromagnets to correct the object's motion, thus forming a servomechanism.

Therefore, the lift system shall use alternating magnetic attraction pulling upwards against gravity providing some inherent lateral stability.

In short, the lift system shall operate as follows; the capsule cuts a beam of light from location sensors to indicate its position. The electromagnet 16 above it is activated, pulling the magnetized capsule into levitation; the electromagnet 17 is turned off whenever the capsule gets too close, and the next one is then turned on to prevent the capsule from falling back.

Such a simple system may not look very robust but far more effective control systems exist. However this illustrates the basic idea.

The electromagnets can be set facing each other at certain intervals, resulting in a crisscross (zigzag) movement 15. This may be helpful in shaking the contents of the capsule.

The whole system will be controlled and monitored by a Lift System Control Box, coupled with a capsules dispenser, set at the upper level.

Rotor/Helical Tube

The helical tube enables the descent of the bucky-balls capsule in a defined path. It performs the function of the rotor in an AC generator. The number of helices is a function of the height of the tube, the size of the capsule and the required angle of descent. The helix 19, sometimes also called a coil, is a curve for which the tangent makes a constant angle with a fixed line.

The tube 20 shall be manufactured out a shape memory polymer (SMP) or a semi-rigid toughened or tempered glass, in order to prevent magnetic loss (in case of metal tube).

The helical coils 21 are subject to torsional loadings, similar to springs, as well as internal wear from friction with the free-falling capsules.

The rotor can consist of several helical tubes 22 set in parallel where the capsules move at a set interval from one another in the different helices. In this configuration, the rotor can be considered as a full magnet, just as in a standard power generator.

The Helix can come in enantiomorphous left (coils counterclockwise as it “goes away”) or right-handed forms (coils clockwise).

The Helix can also be configured as an Archimedean spiral 23, at least in its lower coils, in order to ensure fast movement of the capsules at the bottom of the helix. However, this may necessitate an appropriate design of the central rod/stator in order to ensure and determine how tightly the spiral is “wrapped”.

Vacuum Pump

A vacuum pump 10 is planned at the bottom of the helical tube in order to remove air from the tube thus creating a partial vacuum. The capsule creates a pressure wave as it descends the tube, and this compressed air acts as a drag that hampers free and fast flow.

Since the goal is to achieve a low vacuum in order to prevent structural damage to the helical tube (from atmospheric pressure), a dispositive displacement pump is considered as the suitable technique.

Powerwall Batteries

The Capsule Lift System, as well as other functions in the system, will be powered initially by a set of powerwall batteries.

The powerwall batteries set 9 will be charged with electricity generated from solar panels, or when utility rates are low. The set will power the system in the evening.

The set purpose will be as the system stable power supply that will fortify the system against power outages by providing a backup electricity supply. Automated, compact and simple to install, the powerwall batteries set will offer the security of an emergency backup.

Capsule Dispenser

A major component of the Shlomo's Pillar power plant is the capsule dispenser system. At start, and during steady operation, the capsule dispenser 6 will extrude the bucky-ball capsules at specific intervals into one or more helical tubes that perform as rotors. The dispenser system will control the feeding rate so that the power generator output will be as efficient as possible. The feeding rate will be a function of the descent speed of the capsules in order to prevent collision between capsules. The dispenser system will receive inputs from sensors along the helical tube in order to monitor the rate of feed.

The capsule dispenser will also monitor the ascent speed of the capsules and will keep inventory of the capsules in the canister. There may be several capsule dispensers if there are several helical tubes. The dispenser system will coordinate between the feed rate and dispenser timing.

Solar Panels

The Shlomo Pillar will be covered by solar panels 8 made of photovoltaic modules. The goal of the solar panels is to power the capsules lift system during daylight, as well as store extra electricity in the powerwall batteries for night operation. The solar panels are an integral part of the system as a “starter” component. The solar panels will also enable maximizing energy renewable resource.

Wind Turbines

A wind turbine can be installed on top of a Shlomo's Pillar instead of solar panels. However, since the wind turbine converts kinetic energy into electrical power, it may cause further problems of stability for the Shlomo's Pillar in an integrated structure. On the other hand, an horizontal axis wind turbine can be employed as “starter” for Shlomo's Pillar in less sunny environments.

Power Plant Configurations

Obviously, a single Shlomo Pillar cannot perform as a significant power station and, as with wind farms. Several Shlomo Pillars can be used in the same location to produce electricity. Contrary to a wind farm that requires an extended area of hundreds of square miles to accommodate several individual wind turbines, Shlomo Pillars require a much reduced physical area.

Shlomo Pillars can be set in typical clusters which can be called Ranch, and connected to the grid 23, 26 via a transformer 24, 27. The possible configurations may be Wall 25 (or straight line—A, B, C . . . ) configuration, Circus 28 (or cluster—A, B, C . . . ) or any configuration that suits the installation terrain topology.

1. An emission-free, environmental friendly electrical generator comprising:
a. Magnetic capsules filled with highly magnetized buckminsterfullerene (or bucky ball)—instead of fixed magnets.
b. Helical tube for free fall by gravity of the relatively lightweight yet highly magnetized capsules along the tube. It performs as the rotor.
c. A central, static rod or shaft that performs as the stator.

2. The rotor may consist of one or more helical tubes (instead of coils) where the magnetized capsules rotate in their path. The magnetic capsules descend on free fall, inducing electrical current in the stator that may be comprised of magnets.

3. The capsules are sent back to the top of the helical tube by a magnetic levitation lift system. The inertial momentum of the falling and rotating capsules provides the initial force to speed the capsules up in the lift system. The lift system is powered by solar panels or wind powered generator. The lift system also includes a dispenser feed sub-system to control rate of descending capsules.
